(19) United States
(12) Patent Application Publication
(10) Pub. No.: US 2026/0163979 A1
(43) Pub. Date: Jun. 11, 2026

(54) HANDLING OF DISCONNECTED CALLS IN AN OMNICHANNEL CALL CENTER

(71) Applicant: INTERNATIONAL BUSINESS MACHINES CORPORATION, ARMONK, NY (US)

(72) Inventors: Fang Lu, Billerica, MA (US); John Russell Gerberich, Palatine, IL (US); Zachary Augustus Silverstein, Georgetown, TX (US); Jeremy R. Fox, Georgetown, TX (US); Logan Bailey, Atlanta, GA (US)

(21) Appl. No.: 18/972,789

(22) Filed: Dec. 6, 2024

(51) Int. Cl. H04M 3/523; G10L 15/26; H04M 3/22

(52) U.S. Cl. CPC H04M 3/5231; G10L 15/26; H04M 3/22

(57) ABSTRACT

In an omnichannel call center, a voice call between a caller and an agent is monitored, including generating text of the voice call in real time, and using Natural language processing (NLP) on the text to determine whether the call has been prematurely disconnected. If the call was prematurely disconnected, an alternative communication channel between the caller and the agent is established.

### BACKGROUND

### Technical Field

The present disclosure generally relates to telecommunications, and particularly, to omnichannel call centers.

### Description of the Related Art

A call center typically refers to a team of customer service specialists who field customer calls. A traditional call center tends to specialize in phone calls. An omnichannel call center connects interactions across multiple channels, including voice, email, social media, live chat, and short message service (SMS). Customer context moves with a customer from channel to channel so that agents can personalize requests without making the customer repeat information.

Many different businesses make use of call centers. E-commerce and retail businesses use call centers to assist customers with order inquiries, product information, returns, and complaints. Telecommunications businesses use call centers to provide technical support, billing assistance, and service activation for its subscribers. Banking and financial services use call centers to handle account inquiries, transactions, credit card support, fraud prevention, and dispute resolution. Healthcare companies use call centers to assist patients with appointment scheduling, insurance queries, and general medical information. Travel and hospitality companies use call centers to support travelers with booking, reservation changes, travel information, and customer assistance during travel.

### SUMMARY

According to various embodiments, a computer-implemented method, a computer system, and a computer program product are provided for an omnichannel call center. Monitoring of a voice call between a caller and an agent is performed. The monitoring includes generating text of the voice call in real time, and using Natural language processing (NLP) on the text to determine whether the call has been prematurely disconnected. If the call was prematurely disconnected, an alternative communication channel between the caller and the agent is established.

In some embodiments, computer resources associated with the voice call are conserved after the voice call has been prematurely disconnected.

In some embodiments, an interactive voice response component of the omnichannel call center is used to determine a reason for the call, and a process flow is associated with the reason for the call. The monitoring further includes determining urgency according to tasks remaining to complete the process flow. The establishing of the alternative communication channel is based on a level of urgency.

In some embodiments, a real-time communication channel is selected if urgency is determined, and a non-real-time communication channel is selected if non-urgency is determined.

In some embodiments, the monitoring further includes detecting a tone of the caller's voice in the voice call. The establishing of the alternative communication channel is based on the tone of voice.

In some embodiments, a reason for the call is identified, and a visual representation of a process flow associated with the reason is accessed. Process flow tasks that have been completed and those that remain to be completed are indicated on the visual representation; and the visual representation is sent to a device used by the caller to make the call (the “caller's device”).

In some embodiments, local phone information is received from the caller's device. The local phone information is processed to determine user quality metrics, and a reason for a premature disconnection is determined from the user quality metrics.

In some embodiments, the user quality metrics is shared with other agents at the omnichannel call center.

In some embodiments, local phone information from the caller's device is received. The local phone information includes location of the caller's device and environmental conditions for the caller's device. The selecting of the alternative communication channel is based on the location and the environmental conditions.

In some embodiments, the alternative communication channel is established with a backup recipient instead of the caller.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a particularly configured computing environment that includes a call center component for monitoring voice calls and handling prematurely disconnected calls, consistent with an illustrative embodiment.

FIG. 2 is a block diagram representing call center software, consistent with an illustrative embodiment.

FIG. 3 is a computer-implemented method of monitoring calls and handling prematurely disconnected calls in a call center, consistent with an illustrative embodiment.

FIG. 4 is a computer-implemented method of monitoring calls and handling prematurely disconnected calls in a call center, consistent with an illustrative embodiment.

### DETAILED DESCRIPTION

### Overview and Support

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

According to an embodiment of the present disclosure, a computer-implemented method, a computer system, and a computer program product are provided for an omnichannel call center. Monitoring of a voice call between a caller and an agent is performed. The monitoring includes generating text of the voice call in real time, and using Natural language processing (NLP) on the text to determine whether the call has been prematurely disconnected. If the call was prematurely disconnected, an alternative communication channel between the caller and the agent is established.

The method, computer system, and computer program product provide a fast and efficient way of seamlessly continuing communications with a caller and performing any outstanding tasks within a required time frame in the event a voice call is prematurely disconnected. Identifying when a voice call is prematurely disconnected, assessing a location in the process flow, selecting an alternative communication channel in view of the urgency of completing the process flow, and switching to that communication channel, all in very short time, is beyond the capability of human agents at call centers.

The method conserves computational resources and improves computational efficiency by switching to the alternative channel rather than waiting for the voice call to resume. As a call center typically handles a large number of callers, the conservation of computational resources and improvement of computational efficiency can be significant.

In some embodiments, which can be combined with the previous embodiment, computer resources associated with the voice call are conserved after the voice call has been prematurely disconnected. For instance, computational resources spent on an intelligent virtual assistant may be shifted elsewhere. This further improves computational efficiency.

In some embodiments, which can be combined with one or more of the previous embodiments, an interactive voice response component of the omnichannel call center is used to determine a reason for the call, and a process flow is associated with the reason for the call. The monitoring further includes determining urgency according to tasks remaining to complete the process flow. The establishing of the alternative communication channel is based on a level of urgency. This improves efficiency of seamlessly continuing communications with a caller

In some embodiments, which can be combined with one or more of the previous embodiments, a real-time communication channel is selected if urgency is determined, and a non-real-time communication channel is selected if non-urgency is determined. This results in an efficient allocation of resources and communications bandwidth.

In some embodiments, which can be combined with one or more of the previous embodiments, the monitoring further includes detecting a tone of the caller's voice in the voice call. The establishing of the alternative communication channel is based on the tone of voice. If a caller becomes frustrated and hangs up, computer resources spent up to that point will have been wasted. Responding to the urgency of the caller's tone reduces the likelihood of the caller hanging up and wasting computer resources.

In some embodiments, which can be combined with one or more of the previous embodiments, a reason for the call is identified, and a visual representation of a process flow associated with the reason is accessed. Process flow tasks that have been completed and those that remain to be completed are indicated on the visual representation; and the visual representation is sent to the caller's device. This informs the caller of the caller's progress in the process flow and indicates the tasks that still need to be performed.

In some embodiments, which can be combined with one or more of the previous embodiments, local phone information is received from the caller's device. The local phone information is processed to determine user quality metrics, and a reason for a premature disconnection is determined from the user quality metrics. This helps to understand why the voice call was prematurely disconnected.

In some embodiments, which can be combined with one or more of the previous embodiments, the user quality metrics is shared with other agents at the omnichannel call center. Computational burden is reduced, as other agents do not have to duplicate efforts to identify a reason for calls that are prematurely disconnected.

In some embodiments, which can be combined with one or more of the previous embodiments, local phone information from the caller's device is received. The local phone information includes location of the caller's device and environmental conditions for the caller's device. The selecting of the alternative communication channel is based on the location and the environmental conditions. This ensures that the location and the environmental conditions will pose obstructions to the alternative communication channel.

In some embodiments, which can be combined with one or more of the previous embodiments, the alternative communication channel is established with a backup recipient instead of the caller. This increases the flexibility of establishing the alternative communications channel.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

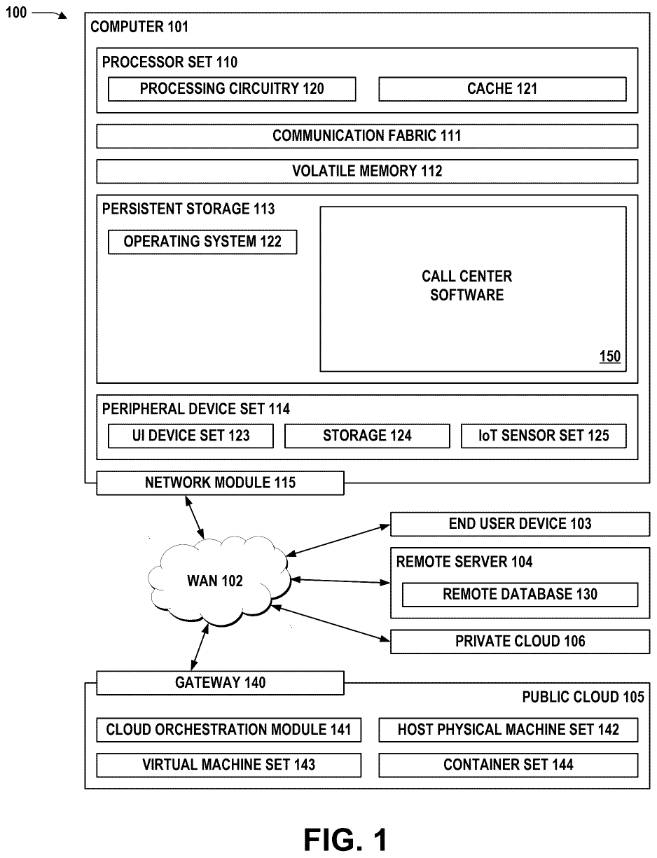

Reference is made to FIG. 1. A computing environment 100 includes an example of an environment for the execution of at least some of the computer code involved in performing the inventive methods. The computing environment 100 includes, for example, computer 101. The computing environment 100 may also include other features, such as a wide area network (WAN) 102, end user device 103, remote server 104, public cloud 105, and private cloud 106. In this embodiment, the computer 101 includes processor set 110, communication fabric 111, volatile memory 112, persistent storage 113 (including operating system 122 and call center software 150), peripheral device set 114 (including user interface (UI) device set 123, storage 124, Internet of Things (IoT) sensor set 125), and network module 115.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

At least some of the instructions for performing the inventive methods may be stored in persistent storage 113 as part of call center software 150. The instructions, when executed, cause the processor set 110 to perform the inventive methods, including monitoring of calls between callers and agents in an omnichannel call center, and handling those calls that are prematurely disconnected.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through a network. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. In some embodiments, remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example Call Center Software

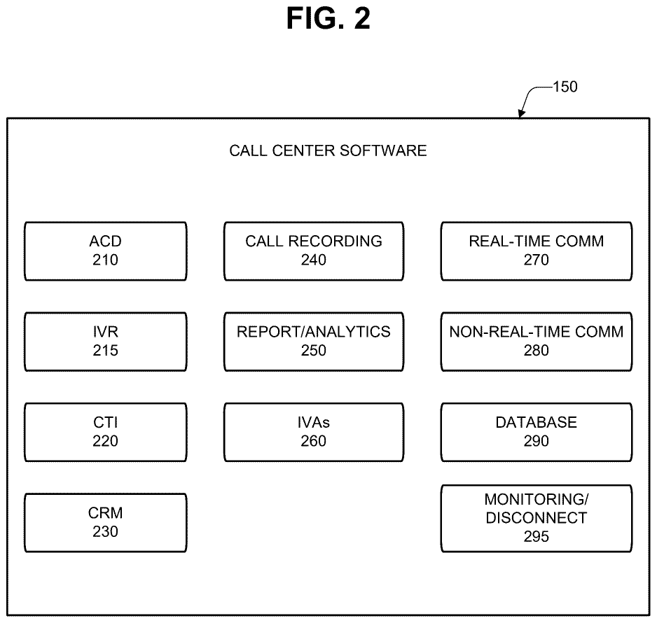

Reference is now made to FIG. 2, which illustrates various software components of the call center software 150. The components include, but are not limited to, an automatic call distributor (ACD) component 210, an interactive voice response (IVR) component 215, a computer telephony integrator (CTI) component 220, a customer relationship management (CRM) component 230, a call recording component 240, and a reporting and analytics component 250. A caller interacts with the IVR component 215, which prompts the caller with menu options and instructs the caller to make a selection. The ACD component 210 uses the selection to route the caller to an agent. The agent may be provided with caller context, such as the name of the person calling, a reason for calling, and any information that helps the agent to address the reason for the call. The CTI component 220 integrates phone systems with computer systems to provide a seamless workflow and access to customer information. The CRM component 230 stores and manages customer data, interactions, and provides a unified view for agents. The call recording component 240 captures and stores recordings for quality assurance, training, and compliance purposes. The reporting and analytics component 250 provide insights into call center performance metrics.

Agents associated with the call center may be human agents and/or intelligent virtual agents (IVAs). Human agents may be located at the call center and/or at remote locations. Human agents at remote locations may use end user devices 103 to communicate with the computer 101.

In the example of FIG. 2, the components of the call center software 150 also include IVAs 260. The IVAs 260 utilizes speech technologies such as Large Language Models, Large Speech Models, Natural Language Understanding (NLU), Natural Language Processing (NLP) and Intelligent Context Gathering, to better understand the context of each call in natural language. The IVAs 260 may also utilize retrieval-augmented generation (RAG) for accurate, contextual, and up-to-date conversational answers, grounded in a relevant knowledge base. The IVAs 260 can simulate live and unstructured cognitive conversations for voice, text and digital interactions, including asking questions, allowing callers to state their reason for calling, and understanding requests and responding in a human-like way.

In addition to the telephony, the call center software 150 includes components 270 for real-time communication channels and components 280 for non-real-time communication channels. Real-time communication channels may include Internet Protocol (IP) telephony, call control, instant messaging (IM), video, and data sharing. Non-real-time communication channels may include voicemail, email, and SMS.

The call center software 150 may include a local database 290 for storing caller profiles. The call center software 150 further includes a component 295 for monitoring phone calls and handling those calls that are prematurely disconnected. Component 295 is described in greater detail below.

In some embodiments, a full complement of software components 210-295 are loaded onto the computer 101. In other embodiments, less than a full complement is loaded onto the computer 101.

In still other embodiments, only component 295 is loaded onto the computer 101, and the other components are distributed among other computers and/or between multiple locations. For example, component 295 is located at the computer 101, and the ACD component 210, the IVR component 215, the CTI component 220 and the CRM component 230 are loaded onto a second computer at a different location. The IVAs 260 are also loaded onto the second computer, and access Large Language Models in the public cloud 105. The call recording component 240, the reporting and analytics component 250 and the local database 290 are located in the private cloud 106.

However, to keep this presentation as simple as possible, all of the components 210-295 are shown as being loaded onto computer 101, and the computer 101 will hereinafter referred to as the “Call Center.”

### Example Method

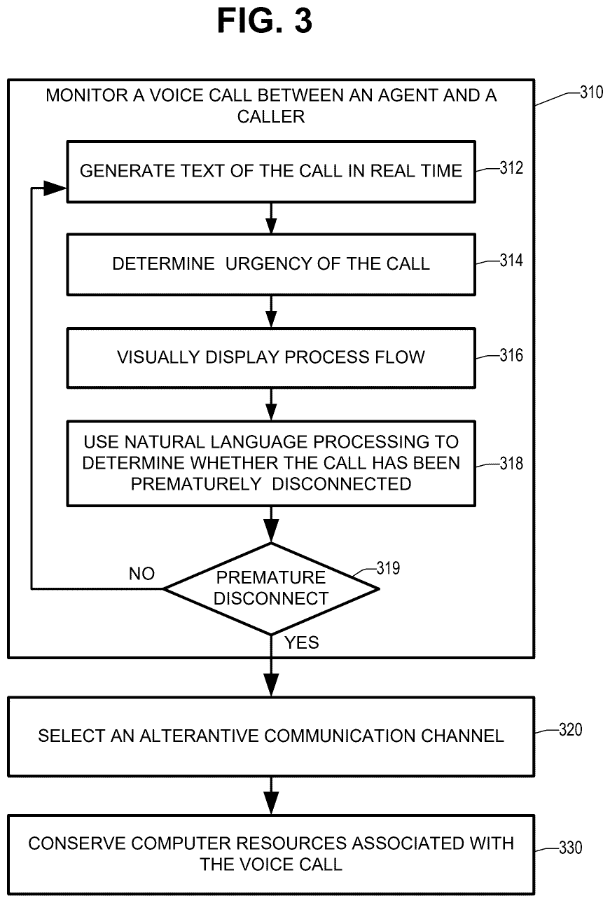

Reference is made to FIG. 3, which illustrates a computer-implemented method for monitoring phone calls to the Call Center and handling those calls that are prematurely disconnected. Callers can make calls to the Call Center using devices such as telephones, smartphones, tablets, desktop computers, etc. When a caller makes a voice call to the Call Center, the caller interacts with the IVR component 215, which prompts the caller with menu options and instructs the caller to make a selection. Selection of the menu option reveals a reason for the call. The ACD component 210 uses the selection to route the caller to an agent.

When the agent is connected with the caller, the agent will follow a set of pre-defined tasks (the “process flow”). The tasks may include a starting task (e.g., the agent greets the caller with a call script) and one or more completion tasks (e.g., the call is forwarded to technical support or another department). The process flow may be represented by a check list, diagram or a graphical representation (e.g., a flowchart). For example, Business Process Model and Notation (BPMN) or Case Management Model and Notation (CMMN) may be used to design and visualize the process flow. BPMN provides a graphical notation for specifying business processes in a diagram that is based on flowcharting techniques. CMMN is a modeling language and framework for case management that deals with unpredictable, ad-hoc, and complex processes. In BPMN, an action step represents a task within a structured, predefined process. In CMMN, an action step represents a task within a flexible, case-driven process.

The voice call between the caller and the agent is monitored (block 310). During monitoring, text of the call is generated in real time (block 312). For example, the CTI component 220 generates an audio stream of the call between a caller and a human agent, and the component 295 uses a speech-to-text converter to perform real-time conversion of the audio stream. As for speech between a caller and an IVA 260, the IVA 260 may perform the speech-to-text conversion.

Urgency of the call is determined (block 314). As used herein, urgency may refer to process flow urgency, or emotional urgency, or both. As used herein, process flow urgency refers to delays or unmet rules (e.g., Service Level Agreement rules) in a process flow. A delay may be detected by monitoring process flow data and evaluating the progression and timing of tasks in the process flow. If a delay or unmet rule is detected, the call is characterized as urgent.

As used herein, emotional urgency refers to urgency based on caller emotion such as distress, anger or frustration. If any of these emotions are detected, the call is characterized as urgent. The component 295 may further include a trained machine learning model (e.g., a neural network or a support vector machine) that receives the text and/or audio input of the call as inputs and classifies the call as urgent or non-urgent. NLP and NLU may also be applied to the text to determine the urgency.

The component 295 may have the process flow visually displayed to the caller (block 316). For instance, the component 295 annotates the graphical representation of the process flow to indicate the completed tasks, and sends the annotated representation to the caller's device. The caller's device displays the annotated representation. This informs the caller of the caller's progress in the process flow and indicates the tasks that still need to be performed. If the call is prematurely disconnected, the annotated representation will tell the caller about the tasks that will be carried out over the alternative communication channel.

NLP and NLU may also be used on the text to determine whether the call has been prematurely disconnected (block 318). The NLP can determine which tasks have already been performed and correlate those tasks to the process flow.

The NLP can also determine when the call is disconnected. For instance, the call is considered disconnected if the caller's spoken words end abruptly (e.g., mid-sentence) followed by a period of silence (e.g., 1 minute), or if the caller's spoken words become unintelligible over a time period (due, for example, to a poor connection), or if the caller's spoken words indicate an obstruction is about to be encountered (e.g., the caller states that a tunnel is about to be entered) followed by silence, or if the audio stream of the call is interrupted or stops unexpectedly, or if some other event that indicates that the call will be disconnected occurs. If a call has been disconnected before a completion task has been performed, the call is considered prematurely disconnected.

If the call was prematurely disconnected (block 319), an alternative communication channel between the caller and the agent is selected (block 320). The component 295 may determine the severity and the necessary timeline to complete the process flow, and then determine the alternative communication channel accordingly. If real-time communications are required to complete the process flow, the caller is contacted via IP telephony, call control, instant messaging, video, or data sharing. If the process flow indicates that non-real-time communications would suffice, the caller may be contacted via voicemail, email, or SMS. In some embodiments, BPMN and CMMN can effectively model how to determine the appropriate communication type (real-time or non-real-time) based on the interruption of a process flow.

The selection of an alternative communication channel may also be based on the urgency of the caller. If urgency is not detected, then the component 295 may use a non-real-time communication channel. If urgency is detected, a real-time communication channel may be used.

There may be a default order of channels to follow. If, however, the caller has a profile, and the profile indicates a preferred alternative channel, the preferred communication channel is selected.

In addition to selecting an alternative communication channel, an alternative recipient may be selected. By default, the call would continue with the caller over the alternative communication channel. However, if the caller's profile specifies a backup recipient in the event a call is disconnected, then subsequent communications would be directed to the backup recipient.

After the alternative communication channel has been selected, any computer resources associated with the voice call are conserved (block 330). For instance, if the agent is an IVA, computer resources devoted to the IVA are freed up.

The voice call made to the Call Center is not limited to any particular type. As a first example, the voice call is made via a public switched telephone network (PTSN), and the alternative communication channel is video via the Internet. As a second example, the voice call is a VoIP call, and the alternative communication channel is a cellular channel. The Call Center may also monitor network conditions, use technologies such as Session Initiation Protocol (SIP) trunking, and cellular gateways, and implement seamless switching protocols to ensure that the communication with the caller remains continuous and of high quality in the event the Internet goes down.

The method of FIG. 3 provides a fast and efficient way of seamlessly continuing communications with a caller and performing any outstanding tasks within a required time frame in the event a voice call is prematurely disconnected. Identifying when a voice call is prematurely disconnected, assessing a location in the process flow, selecting an alternative communication channel in view of the urgency of completing the process flow, and switching to that communication channel, all in very short time, is far beyond the capability of human agents at call centers.

The method conserves computational resources and improves computational efficiency by switching to the alternative channel rather than waiting for the voice call to resume. For instance, computational resources spent on an IVA may be shifted elsewhere. As a call center typically handles a large number of callers, the conservation of computational resources and improvement of efficiency can be significant.

### Examples of Use Cases

A first example use case involves a caller who uses a smart phone to call the Call Center to resolve medical billing issues with a health insurance provider. An agent takes the call, performs a few tasks, and the puts the caller on hold. After being on hold for a while, the caller starts to show frustration with the lack of progress. The NLP interprets the long silence as a prematurely disconnected call and reaches out to the caller through a more robust real-time alternative, such as a messaging platform or a video call, to complete the process flow. A visual representation of the process flow is sent to the smart phone for display so the caller can validate how far the process flow has progressed. This visualization really helps the caller understand where the caller is within the process while working with the medical insurance company.

A second example use case involves a caller who uses a smart phone to call the Call Center to resolve a credit card dispute with a large bank. A credit card charge is at issue. The call is routed to an agent. The component 295 detects that the caller has been disconnected from the Call Center and identifies the urgency of his call based on the intent and the timeline of the communication. The component 295 reaches out to the caller through a more robust alternative, such as a messaging platform or a video call, to complete the process flow. A visual representation of the process flow is sent to the smart phone for display so the caller can validate where the call was disconnected and understands the context of the tasks that remain.

### Another Example Method

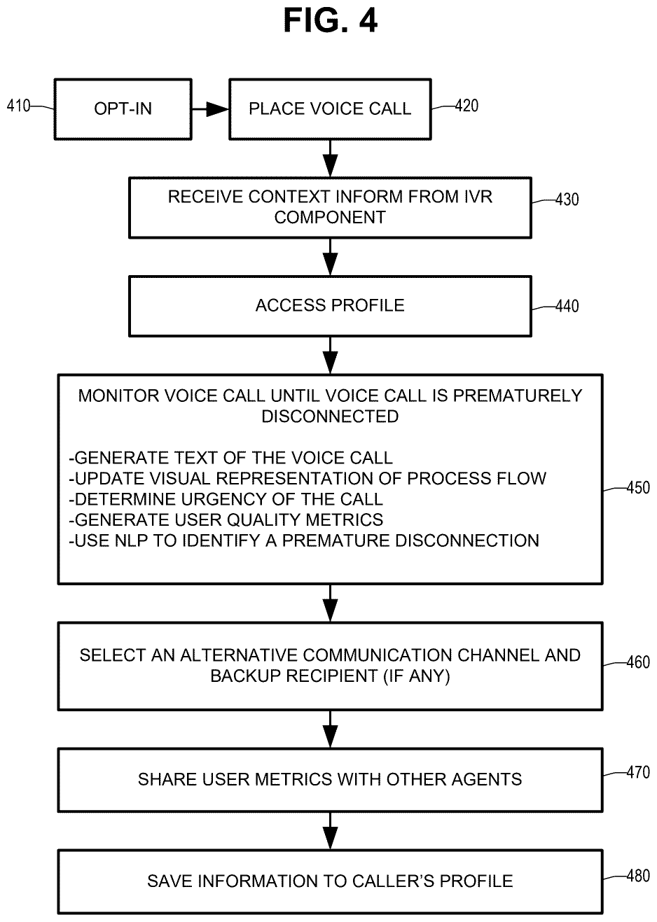

Reference is now made to FIG. 4, which illustrates a method having some additional features. The method of FIG. 4 will be described in connection with a smart phone. The smart phone is loaded with a Call Center app that, when executed by the smart phone, can communicate with the Call Center. The app enables a caller to opt-in and give permission for the smart phone to send local information to the Call Center during a voice call. The local information may include location (e.g. GPS coordinates), ambient weather conditions, and user quality metrics (e.g., strength of signal).

At block 410, a caller opts in prior to placing a call to the Call Center. At block 420, the caller places a voice call to the Call Center with the smart phone. The caller interacts with the IVR component 215.

At block 430, the IVR component 215 collects context information from the caller. The context information may include the name of the caller, the reason for calling, and any information that about the reason for the call. Additional context information may include history of actions, and timeline of actions. The ACD component 210 routes the caller and the context information to an agent and also to the component 295.

At block 440, the component 295 looks up the name of the caller. If the caller has a profile, the component 295 accesses the profile.

The voice call begins. At block 450, the component 295 monitors the voice call between the caller and the agent. The monitoring includes generating text of the voice call in real time, determining the urgency of the call, and using the NLP on the text to determine whether the voice call has been prematurely disconnected. The NLP is also used to identify those tasks in the process flow that have been completed. The component 295 updates a visual representation of the process flow to indicate the completed tasks, and sends the updated visual representation to the smart phone of the caller.

The monitoring also includes generating user quality metrics from the local information sent by the smart phone. If the user metrics indicate signal degradation, the component 295 may determine the cause of the signal degradation. For instance, the component 295 may look up the GPS coordinates of the smart phone on a map to determine whether it is near an obstruction. The component 295 may also examine environmental conditions (e.g., ambient weather conditions) to determine whether any of those conditions (e.g., rain or fog) is interfering with the call.

At block 460, if the voice call is prematurely disconnected, the component 295 selects an alternative communication channel. The alternative communication channel is selected in view of the urgency of completing the process flow. In addition, the selection ensures that the alternative communication channel is not affected by the geographic or environmental obstructions.

By default, the alternative communication channel may be used to contact the caller. However, if the caller specifies a backup recipient (e.g., an emergency contact) during the call, or the caller's profile specifics a backup recipient, the alternative communication channel may be used to contact the backup recipient instead of, or in addition to, the caller.

At block 470, the user metrics may be shared with other agents, who can apply the user metrics to their own calls. Consider an example in which the user metrics indicate signal degradation at a particular location, and a map indicates an obstruction at that location. The component 295 shares the metrics and the GPS coordinates with other agents. If another agent is on a call with a caller entering that particular location, that other agent can select an alternative communication channel before the call is prematurely disconnected.

At block 480, the call recording component 240 may be used to record a resolutions or lack thereof, and save the information to the caller's profile for future reference. If the caller specified a new or different preferred alternative channel or a new or different preferred backup, that information may also be saved to the caller's profile.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for an omnichannel call center, the computer-implemented method comprising:
monitoring a voice call between a caller and an agent, comprising;
generating text of the voice call in real time; and
using natural language processing (NLP) on the text to determine whether the call has been prematurely disconnected; and
if the call was prematurely disconnected, establishing an alternative communication channel between the caller and the agent.

2. The computer-implemented method of claim 1, further comprising conserving computer resources associated with the voice call after the voice call has been prematurely disconnected.

3. The computer-implemented method of claim 1, wherein:
an interactive voice response component of the omnichannel call center is used to determine a reason for the voice call;
a process flow is associated with the reason for the voice call;
the monitoring further comprises determining urgency according to tasks remaining to complete the process flow; and
the establishing of the alternative communication channel is based on a level of urgency.

4. The computer-implemented method of claim 3, wherein:
a real-time communication channel is selected if urgency is determined; and
a non-real-time communication channel is selected if non-urgency is determined.

5. The computer-implemented method of claim 1, wherein:
the monitoring further comprises detecting a tone of the caller's voice in the voice call; and
the establishing of the alternative communication channel is based on the tone of the caller's voice.

6. The computer-implemented method of claim 1, further comprising:
identifying a reason for the voice call;
accessing a visual representation of a process flow associated with the reason;
indicating process flow tasks that have been completed and those that remain to be completed on the visual representation; and
sending the visual representation to a device used by the caller to make the voice call.

7. The computer-implemented method of claim 1, further comprising:
receiving local phone information from a device used by the caller to make the call;
processing the local phone information to determine user quality metrics; and
determining a reason for a premature disconnection from the user quality metrics.

8. The computer-implemented method of claim 7, further comprising:
sharing the user quality metrics with other agents at the omnichannel call center.

9. The computer-implemented method of claim 1, further comprising:
receiving local phone information from a device used by the caller to make the call, the local phone information including location of the device and environmental conditions for the device; and
selecting the alternative communication channel based on the location and the environmental conditions.

10. The computer-implemented method of claim 1, wherein:
the alternative communication channel is established with a backup recipient instead of the caller.

11. A computer system for an omnichannel call center, the computer system comprising a memory having computer readable instructions; and one or more processors for executing the computer readable instructions to configure the computer system to perform a method comprising:
monitoring a voice call between a caller and an agent at the omnichannel call center, wherein the monitoring includes;
generating text of the voice call in real time; and
using natural language processing (NLP) on the text to determine whether the call has been prematurely disconnected; and
if the call was prematurely disconnected, establishing an alternative communication channel between the caller and the agent.

12. The computer system of claim 11, wherein:
an interactive voice response component of the omnichannel call center is used to determine a reason for the voice call;
a process flow is associated with the reason for the voice call;
the monitoring further comprises determining urgency according to tasks remaining to complete the process flow; and
the establishing of the alternative communication channel is based on a level of urgency.

13. The computer system of claim 12, wherein:
a real-time communication channel is selected if urgency is determined; and
a non-real-time communication channel is selected if non-urgency is determined.

14. The computer system of claim 11, wherein the method further comprises:
receiving local phone information from a device used by the caller to make the call;
processing the local phone information to determine user quality metrics; and
determining a reason for a premature disconnection from the user quality metrics.

15. The computer system of claim 11, wherein the method further comprises:
identifying a reason for the voice call;
accessing a visual representation of a process flow associated with the reason;
indicating process flow tasks that have been completed and those that remain to be completed on the visual representation; and
sending the visual representation to a device used by the caller to make the voice call.

16. A computer program product comprising one or more computer-readable memory devices encoded with data including instructions that, when executed, causes a processor set to carry out a method for an omnichannel call center, the method comprising:
monitoring a voice call between a caller and an agent at the omnichannel call center, wherein the monitoring includes;
generating text of the voice call in real time; and
using natural language processing (NLP) on the text to determine whether the call has been prematurely disconnected; and
if the call was prematurely disconnected, establishing an alternative communication channel between the caller and the agent.

17. The computer program product of claim 16, wherein:
an interactive voice response component of the omnichannel call center is used to determine a reason for the voice call;
a process flow is associated with the reason for the voice call;
the monitoring further comprises determining urgency according to tasks remaining to complete the process flow; and
the establishing of the alternative communication channel is based on a level of urgency.

18. The computer program product of claim 17, wherein:
a real-time communication channel is selected if urgency is determined; and
a non-real-time communication channel is selected if non-urgency is determined.

19. The computer program product of claim 16, wherein the method further comprises:
receiving local phone information from a device used by the caller to make the call;
processing the local phone information to determine user quality metrics; and
determining a reason for a premature disconnection from the user quality metrics.

20. The computer program product of claim 16, wherein the method further comprises:
identifying a reason for the voice call;
accessing a visual representation of a process flow associated with the reason;
indicating process flow tasks that have been completed and those that remain to be completed on the visual representation; and
sending the visual representation to a device used by the caller to make the voice call.
